(19) United States
(12) Patent Application Publication
(10) Pub. No.: US 2017/0213165 A1
(43) Pub. Date: Jul. 27, 2017

(54) SYSTEMS AND METHODS FOR VEHICLE RIDE SAFETY AND SECURITY OF PERSON AND PROPERTY

(71) Applicant: GM GLOBAL TECHNOLOGY OPERATIONS LLC, Detroit, MI (US)

(72) Inventors: LOUISE E. STAUFFER, BLOOMFIELD HILLS, MI (US); MARY E. DECALUWE, OXFORD, MI (US); JIM K. RAINBOLT, HASLETT, MI (US); SPENCER W. CHAMBERLAIN, STERLING HEIGHTS, MI (US); JANET S. GOINGS, COMMERCE TOWNSHIP, MI (US); CARL W. WELLBORN, DETROIT, MI (US); JOSEPH NEIGHBORS, MILFORD, MI (US); JASON E. DIEHL, WASHINGTON TOWNSHIP, MI (US); SCOTT LUMSDEN, ROCHESTER HILLS, MI (US); BRYAN M. QUINTANILLA, DETROIT, MI (US); VINCENT K. TRAINA, BLOOMFIELD, MI (US); PAUL W. ALEXANDER, YPSILANTI, MI (US); JOSEPH F. SZCZERBA, GRAND BLANC, MI (US); VIVIEN MARTINAGE, GROSS POINT FARMS, MI (US); ROY J. MATHIEU, ROCHESTER HILLS, MI (US)

(73) Assignee: GM GLOBAL TECHNOLOGY OPERATIONS LLC, Detroit, MI (US)

(21) Appl. No.: 15/414,315

(22) Filed: Jan. 24, 2017

Related U.S. Application Data
(60) Provisional application No. 62/287,431, filed on Jan. 26, 2016.

(51) Int. Cl. G06Q 10/02

(52) U.S. Cl. CPC G06Q 10/02; G06Q 50/30

(57) ABSTRACT

A methods and a server for operating a vehicle are provided. A method includes selecting an identifier that is associated with a vehicle reservation for passenger service in the vehicle. The method further includes initiating a pick-up portion of the vehicle reservation for making the vehicle available to a passenger. The method further yet includes displaying the identifier at the vehicle during the pick-up portion of the passenger service. The server includes a processor and a non-transitory computer readable medium storing instructions that configure the server for performing the method.

### CROSS-REFERENCE TO RELATED APPLICATIONS

This application claims the benefit of U.S. Provisional Application No. 62/287,431 filed on Jan. 26, 2016. The disclosure of the above application is incorporated herein by reference.

### TECHNICAL FIELD

Embodiments of the subject matter described herein relate generally to vehicle passenger services, and more particularly relates to methods and systems for vehicle ride safety and security of person and property.

### BACKGROUND

An autonomous vehicle is a vehicle that is capable of sensing its environment and navigating with little or no user input. An autonomous vehicle senses its environment using sensing devices such as radar, lidar, image sensors, etc. The autonomous vehicle system further uses information from systems such as global positioning systems (GPS), vehicle to infrastructure (VtoI) systems, and vehicle to vehicle (VtoV) systems to navigate, plan efficient routes, and avoid traffic.

Application based transportation services are becoming increasingly popular. Conventional application based transportation services connect a user with a local driver who is available to take the user from point A to point B. The driver typically uses their own personal vehicle to transport the user. In these conventional transportation services the driver is able to visually and verbally confirm that the passenger has completed the trip or reservation.

In some instances, it would be desirable to use autonomous vehicles instead of driver based vehicles for the transportation. In such instances, however, a human driver is not present to help a passenger feel safe within the vehicle or to help the passenger by alerting them to inadvertently abandoned personal property in the autonomous vehicle.

Accordingly, it is desirable to provide methods and systems for autonomous vehicle ride safety and security of person and property. Furthermore, other desirable features and characteristics of the present invention will become apparent from the subsequent detailed description and the appended claims, taken in conjunction with the accompanying drawings and the foregoing technical field and background.

### SUMMARY

Methods and servers are provided for operating vehicles. In some embodiments, a method includes selecting an identifier that is associated with a vehicle reservation for passenger service in the vehicle. The method further includes initiating a pick-up portion of the vehicle reservation for making the vehicle available to a passenger. The method further yet includes displaying the identifier at the vehicle during the pick-up portion of the passenger service.

In some embodiments, displaying the identifier includes projecting the identifier onto the vehicle. In some embodiments, the method further includes ceasing the displaying in response to a pick-up of the passenger. In some embodiments, selecting the identifier includes selecting a graphic that is unique to the vehicle reservation within a predetermined distance from a pick-up location. In some embodiments, selecting the identifier further includes randomly generating the graphic. In some embodiments, the method further includes sending the identifier to a personal device of the passenger to assist with passenger identification of the vehicle. In some embodiments, displaying the identifier includes displaying a likeness of the passenger.

In some embodiments, a method includes: sensing whether an item of personal property is disposed in the autonomous vehicle; detecting whether the passenger has left the autonomous vehicle; and alerting the passenger to the presence of the item of personal property in the autonomous vehicle in response to determining that the passenger has left the autonomous vehicle. In some embodiments, the method further includes securing the item of personal property in a storage space in response to detecting that the passenger has not retrieved the item of personal property, where securing the item of personal property includes disallowing use of the storage space by a subsequent passenger. In some embodiments, the method further includes allocating charges to the passenger for continued use of the storage space. In some embodiments, the method further includes sensing whether an item of personal property is disposed in the autonomous vehicle and includes alerting the passenger to the presence of the item of personal property in response to the autonomous vehicle nearing a destination of the vehicle reservation. In some embodiments, alerting the passenger includes displaying a representation of the item of personal property. In some embodiments, the method further includes determining a dimension and a location of the item of personal property, and where displaying the representation is based on the dimension and the location.

In some embodiments, the method includes: determining whether a first passenger and a second passenger are compatible; and initiating a ride share of the vehicle with the first passenger and the second passenger based at least in part on whether the first passenger and the second passenger are compatible. In some embodiments, the method further includes denying the ride share in response to receiving a denial request from the first passenger. In some embodiments, the method further includes covertly altering a destination of the first passenger to a nearby location in response to a termination request by the first passenger during the ride share.

In some embodiments, the method further includes performing safety procedures in response to a panic mode indication. In some embodiments, the method further includes: detecting an emergency situation following departure of the passenger; and initiating an emergency response action in response to detection of the emergency situation and a return of the passenger to the vehicle. In some embodiments, the method further includes determining whether a threat exists at a current destination and includes selecting a new destination in response to determining that the threat exists at the current destination.

In some embodiments, a method includes operating a vehicle for a passenger. The method further includes sensing whether an item of personal property is disposed in the vehicle. The method further yet includes detecting whether the passenger has left the vehicle. The method further still includes alerting the passenger to the presence of the item of personal property in the vehicle in response to determining that the passenger has left the vehicle.

In some embodiments, a server includes a processor and a non-transitory computer readable medium storing instructions. The instructions configure the server for: selecting an identifier that is associated with a vehicle reservation for passenger service in an autonomous vehicle; initiating a pick-up portion of the vehicle reservation for making the autonomous vehicle available to a passenger; and displaying the identifier at the autonomous vehicle during the pick-up portion of the passenger service.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1A is a simplified block diagram illustrating a system for an autonomous vehicle in accordance with the teachings of the present disclosure;

FIG. 1B is a flow chart illustrating an exemplary embodiment of an autonomous vehicle passenger service method;

FIG. 2 is a flow chart that illustrates an exemplary embodiment of a method for monitoring personal property of a passenger in an autonomous vehicle ride service;

FIG. 3 is a flow chart illustrating an exemplary embodiment of a method for matching ride sharing passengers in an autonomous vehicle ride service;

FIG. 4 is a flow chart illustrating an exemplary embodiment of a method for promoting passenger safety and security in an autonomous vehicle ride service; and

FIG. 5 is a flow chart illustrating an exemplary embodiment of a method for promoting passenger safety and security in an autonomous vehicle ride service.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

For the sake of brevity, conventional techniques related to the control and operation of autonomous (i.e., driverless or self-driving) vehicles, mobile client devices, navigation and mapping systems, the global positioning system (GPS), security and access control systems, shipping and delivery systems, signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter described herein relates to sensor systems and control of automobiles. For example, embodiments disclosed herein are described with reference to an autonomous vehicle based transportation system having at least one driverless vehicle that is automatically controlled to carry passengers from one location to another. The disclosed subject matter provides certain enhanced features and functionality over conventional autonomous vehicle systems. To this end, an autonomous vehicle based transportation system can be modified, enhanced, or otherwise supplemented to provide the additional features mentioned in more detail below. It should be appreciated that the subject matter may also be applied to other vehicles, such as non-autonomous personally owned or fleet vehicles (e.g, conventional rental cars or taxis) without departing from the scope of the present disclosure.

In general, the disclosure relates to systems and methods for security and safety of person and property in an autonomous vehicle passenger service. The personal safety features include predictive vehicle maintenance, matching ride sharing passengers based on preferences/interests, passenger options to reject ride shares, friend connections for ride shares, stop/panic/emergency procedures, and ride termination request. These features may inspire confidence that the vehicle the user is entering/using is a haven and is safe to trust. The features further promote personal safety and security with confident ride identification, assured the shared transportation will get user to destination with control over who is in vehicle with them and ability to adjust/cancel in transit instantly (panic button or just change of plans).

In some embodiments, as a shared vehicle approaches pick up of a rider, the rider's smartphone vibrates to indicate that the shared vehicle is approaching. The vibration increases or patterns (syncs) as the vehicle grows nearer. In some embodiments, the vibration is coordinated/harmonized with color/light/sound from vehicle for confirmation to the rider that they are approaching the correct vehicle. In some embodiments, a visible display on an outside of the shared car shows a picture/icon/likeness and/or name or other identifier of the rider to be picked up. In some embodiments, the vehicle uses VHM predictive analytics to predict ahead of time when maintenance is required (e.g., brakes, battery, oil change, etc.), so vehicle is always trustworthy and is less likely to break down. In some embodiments, rider personal information is available on a software application to match riders of similar interests (sports, music, etc.). The application may show friend connections for trust, and may provide an opportunity to accept/reject/block the connection.

Co-rider preferences may be set in the application as preferences or for each ride to automatically select the yes/no and allowance criteria for shared riders and friend connections. In some embodiments, a rider with low ratings from other previous shared riders may be automatically rejected. In some embodiments, a stop or panic button gives the rider a way to quickly terminate the ride sooner. In some embodiments, the stop or panic input may be a personally programmed gesture of a hand/head/foot or other body language. In some embodiments, the vehicle includes a “turtle mode” if being vandalized (unoccupied mode) or “safeguard mode” if the vehicle senses a threat or occupant indicates feeling unsafe/threatened from outside (e.g., in response to the user pressing a panic button). In the safeguard mode, the vehicle may lock down utilizing any available features, such as shielded windows, run flat tires, drive by sensors, ON-STAR human contact, owner notification, and may be rerouted to the closest or fastest safe haven or police station destination. In some embodiments, a display screen shows the exterior situation of the vehicle if the vehicle is occupied and may warn the rider if the exterior situation holds a potential threat. For example, the occupant can decide to exit the vehicle, call for help, or continue to a safer location without exiting. In some embodiments, the vehicle can communicate to a rider who has not yet entered the vehicle that it is unsafe to approach or enter the vehicle because of a situation occurring inside the vehicle. In some embodiments, the vehicle can communicate to a rider who has not yet entered the vehicle that it is unsafe to approach or enter the vehicle because of a situation occurring inside the vehicle. In some embodiments, the vehicle can communicate to a rider who has not yet entered the vehicle that it is unsafe to approach or enter because of a situation occurring inside the vehicle.

In some embodiments, the vehicle may provide options and ON-STAR human contact to promote situational awareness by the user. In some embodiments, the vehicle utilizes V to V or I to V information for early warning/predictive information gathering that can be used to plan a route/drop off or a pick up location. In some embodiments, the vehicle departs to a safer location and/or alerts authorities. In some embodiments, the vehicle provides the functionality of an emergency vehicle. For example, if a rider boards the vehicle and inputs a panic or other “get me out of here” command, the vehicle will enact the safeguard mode and head to the closest safe haven/police station. If a rider inputs a health emergency command, the vehicle may head to an urgent care or hospital emergency facility. In some embodiments, the vehicle identifies a potential risk increase and provides mitigation actions or options to the passenger. In some embodiments, the vehicle initiates the health emergency command without rider input in response to detecting a health concern with the rider (e.g., the rider has a heart attack, has a stroke, or loses consciousness in the vehicle). In some embodiments, the vehicle may provide call connection with authorities/emergency personnel/health care professional, and may monitor user health and/or respond to directions from contact if rider is unable to respond and/or provide notification to emergency facility of eta and case specifics.

The property safety and security features include detection of objects left in the vehicle, notification of objects left in the vehicle upon passenger exit, vehicle departure delay in response to item detection, and safe storage capability when an object is left in the vehicle. Such features reduce risk of passengers losing, forgetting, or having personal property stolen from a shared or temporary use vehicle/rideshare. The features utilize sensors and alert systems to permit a passenger in a shared vehicle (rideshare or carshare) to keep track of personal property and to ensure the personal property goes with the passenger at the end of the journey. In some embodiments, low energy Bluetooth technology is utilized to communicate to an application or to the vehicle when bins, the trunk, or rear doors have been opened. When nearing a final destination, the application or the vehicle may remind the user to check sensed locations (with quick look schematic on device and/or vehicle display) and may alert the user to take cargo/personal property with them when they leave the vehicle (general or directional sounds to indicate locations to look/feel, voice instructions, or exit indicator light behavior/message, or individual compartments lighting up/flashing, or opening themselves for inspection/item “delivery”). Sensors may include existing sensors for door/deck lid/lift gate opening and seat occupancy, optical sensors, surface tension sensors, electrical outlet sensors, weight differential sensors, and the like. For example, electrical outlet sensors may sense that a 12 volt outlet in the vehicle has something plugged in or is charging. Weight differential sensors may be used to detect what passengers and personal items brought on board weigh. The sensed information may be used to alert the passenger at the end of a trip when something is forgotten (e.g., weight is not fully removed at exit, electrical outlet detects personal item still plugged in). Such personal items often left in vehicles include sunglasses, hats, books, umbrellas, coffee mugs, etc. In some embodiments, open or transparent bins and shelves may be utilized so the user can see where personal items were stowed to remember to take the personal items on exiting the vehicle.

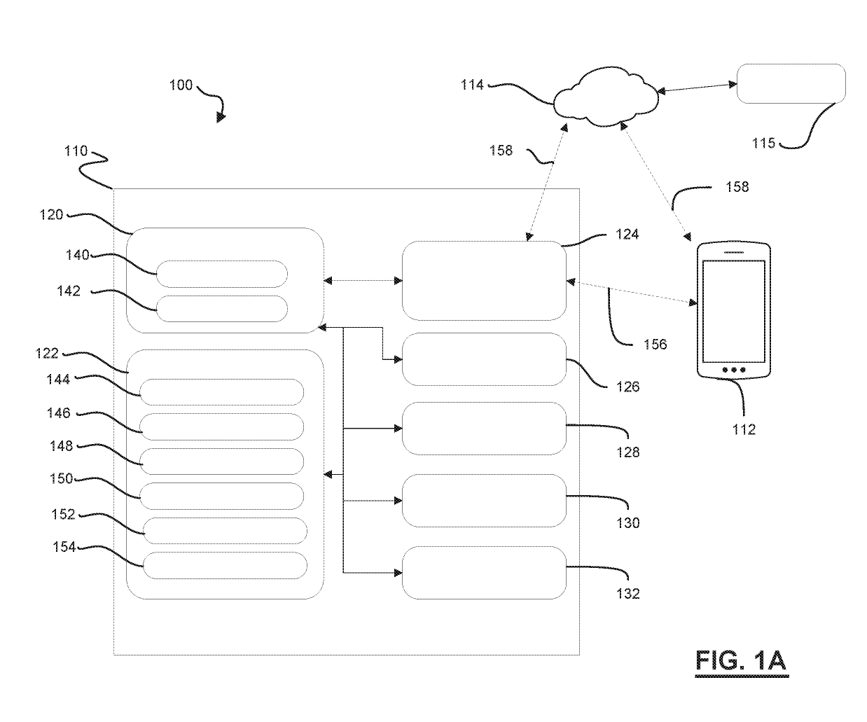

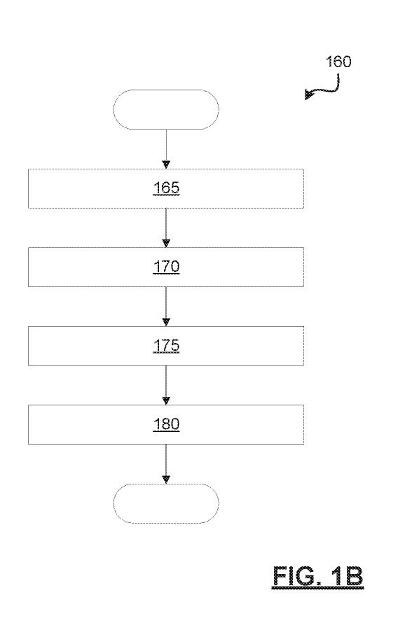

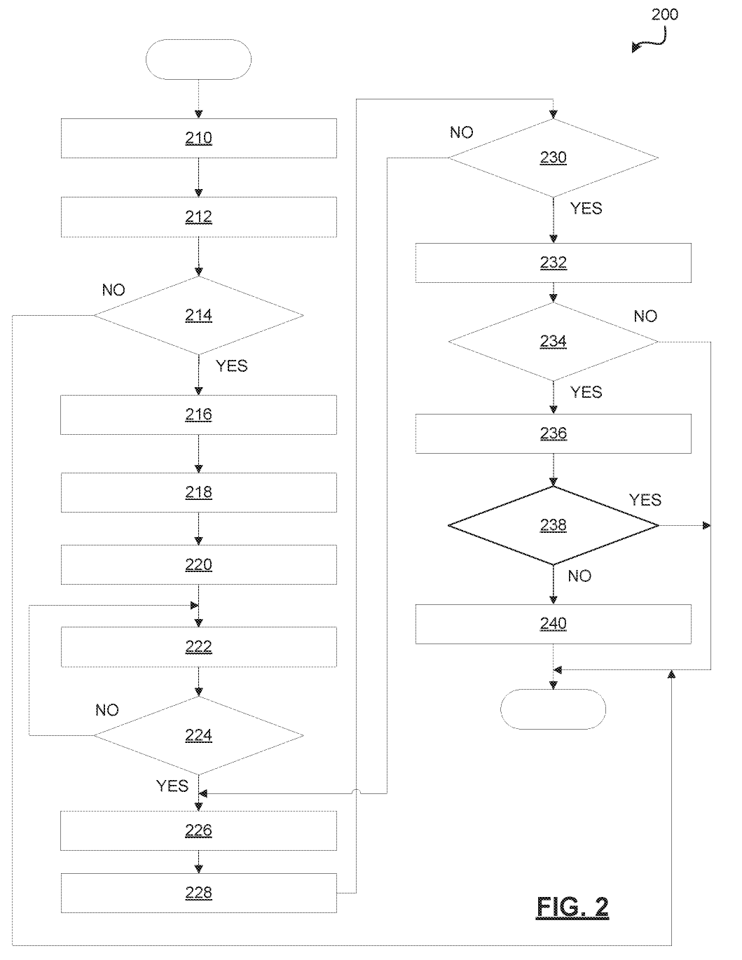

With initial reference to FIG. 1A, a system 100 for safety and security of person and property in an autonomous vehicle passenger service is illustrated as a simplified block diagram in accordance with the present disclosure. In the embodiment provided, system 100 includes an autonomous vehicle 110, a personal device 112, a network 114, and a server 115. Although the disclosure gives the example of an onboard controller to control autonomous vehicle 110 with commands, instructions, and/or inputs that are “self-generated” onboard the vehicle itself, the operations of autonomous vehicle 110 and tasks of FIGS. 2, 3, and 4 may alternatively or additionally be controlled by commands, instructions, and/or inputs that are generated by one or more components or systems external to the vehicle. For example, without limitation, autonomous vehicle 110 may be controlled by other autonomous vehicles, a backend server system, other control devices or systems located remotely from the vehicle, or the like. In certain embodiments, therefore, a given autonomous vehicle can be controlled using vehicle-to-vehicle data communication, vehicle-to-infrastructure data communication, and/or infrastructure-to-vehicle communication without departing from the scope of the present disclosure.

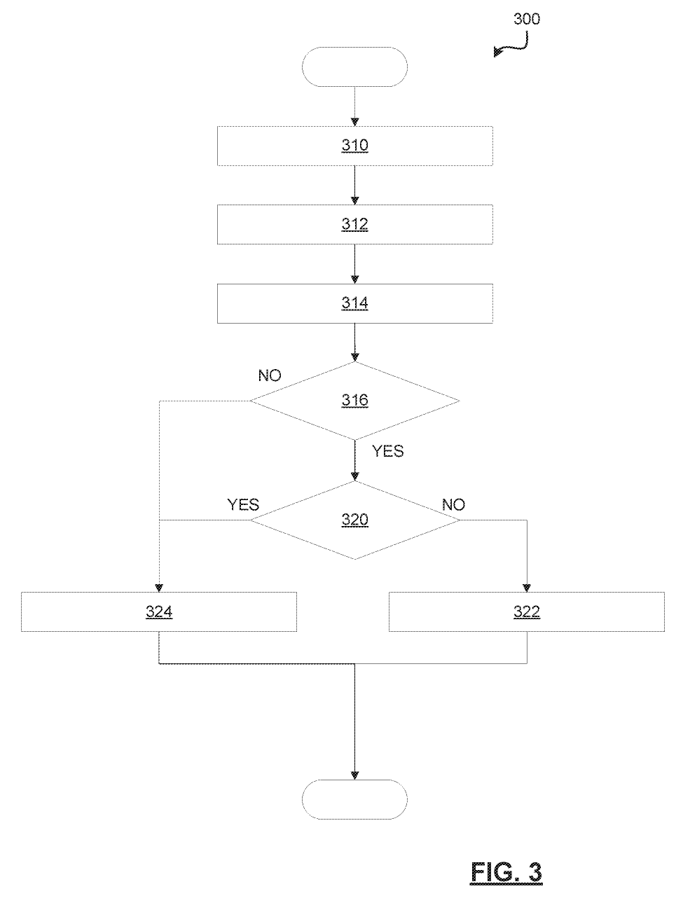

Autonomous vehicle 110 has an “automated” mode in which autonomous vehicle 110 (through a suitable control system and any number of sensors) is configured to monitor its environment and navigate without human (e.g., driver or passenger) interaction. In some embodiments, autonomous vehicle 110 includes a “manual” mode that allows the passenger to assume manual control of autonomous vehicle 110. Although the systems and methods described herein are described in the contexts of an “autonomous” vehicle, the systems and methods are similarly applicable to semi-autonomous and non-autonomous vehicles. The vehicles may be personally owned, publically owned, or fleet owned. Autonomous vehicle 110 includes a controller 120, a plurality of sensors 122, a wireless communications device 124, a user input device 126, a display 128, a projector 130, and an item storage feature 132. It should be appreciated that additional or alternative components may be utilized to perform the various tasks described below with reference to FIGS. 2 and 3 without departing from the scope of the present disclosure.

Controller 120 is in electronic communication with sensors 122, devices 124 and 126, display 128, and projector 130. It should be appreciated that alternative or additional devices may be in electronic communication with controller 120 without departing from the scope of the present disclosure. Controller 120 may include an application specific integrated circuit (ASIC), an electronic circuit, a processor 140 (shared, dedicated, or group) and memory 142 that executes one or more software or firmware programs, a combinational logic circuit, and/or other suitable components that provide the described functionality. For example, processor 140 may include a content addressable memory, a digital signal processor, an application specific integrated circuit, a field programmable gate array, any suitable programmable logic device, discrete gate or transistor logic, discrete hardware components, or any combination designed to perform the functions described here. Moreover, processor 140 may be implemented as a combination of computing devices, e.g., a combination of a digital signal processor and a microprocessor, a plurality of microprocessors, one or more microprocessors in conjunction with a digital signal processor core, or any other such configuration.

Memory 142 may be realized as RAM memory, flash memory, EPROM memory, EEPROM memory, registers, a hard disk, a removable disk, a CD-ROM, or any other form of storage medium known in the art. In this regard, memory 142 may be coupled to processor 140 such that processor 140 can read information from, and write information to, memory 142. At least a portion of memory 142 may be realized as a computer storage medium, e.g., a tangible computer readable media element having non-transitory processor-executable instructions stored thereon. The computer-executable instructions can be configurable such that, when read and executed by processor 140, cause controller 120 to perform certain tasks, operations, functions, and processes described in more detail below. In this regard, memory 142 may represent one suitable implementation of such computer-readable media. Alternatively or additionally, controller 120 may receive and cooperate with computer-readable media (not separately shown) that is realized as a portable or mobile component or platform, e.g., a portable hard drive, a USB flash drive, an optical disc, or the like.

Controller 120 may operate in conjunction with or separate from one or more other automatic vehicle control systems, autonomous driving applications, or vehicle automated steering systems (not shown), such as a vehicle automated steering system providing, for example, adaptive lane centering, low speed lane centering, lane keeping assist, or other applications. Controller 120, when in an “automated mode” fully controls the steering and throttle of vehicle 10 without the need for driver steering control input via a steering wheel and/or other components of the steering system. In general, controller 120 includes any suitable combination of hardware and/or software configured to receive sensor signals and perform the operations described below with reference to the FIGS. In some examples, controller 120 performs tasks of an individualized risk management system associated with an autonomous and/or shared ride for a person and/or cargo. In some examples, the risk management spans vehicle selection, identification, entry, occupation, and exit.

Sensors 122 may include any combination of optical, proximity, occupancy, weight, audio, or other sensors configured to measure conditions both inside of and outside of autonomous vehicle 110. In the example provided, sensors 122 include an occupancy sensor 144, a door/deck lid/lift gate sensor 146, an optical sensor 148, a surface tension sensor 150, a weight sensor 152, and an electrical outlet sensor 154, as will be appreciated by those with ordinary skill in the art. Each of sensors 122 sends sensor signals to controller 120 for processing in accordance with FIGS. 2 and 3, described below.

Wireless communications device 124 may be any device configured to communicate with personal device 112 either directly through data communication channel 156 or through network 114 via data communication channels 158. For example, wireless communications device 124 may include a mobile telephone antenna and any sort of wireless or wired local and/or personal area networks, such as one or more IEEE 802.3, IEEE 802.16, and/or IEEE 802.11 networks, and/or networks that implement a short range (e.g., Bluetooth, near field communication, etc.) protocol. Wireless communications device 124 is also configured to communicate with Vehicle to Infrastructure systems (or Infrastructure to Vehicle systems), Vehicle to Vehicle systems, and other similar systems. It should be appreciated that multiple communications devices may be utilized for communication with different systems without departing from the scope of the present disclosure.

User input device 126 may be any device capable of receiving commands from a passenger of autonomous vehicle 110. For example, user input device 126 may be a keyboard, microphone, gesture sensor, etc. Display 128 may be any device capable of visually presenting images and data for the passenger of autonomous vehicle 110. In the example provided, display 128 is a liquid crystal display that is integrated with user input device 126.

Projector 130 is configured to project a visible image onto a portion of autonomous vehicle 110 that is visible from an exterior of autonomous vehicle. For example, projector 130 may utilize “ghost” or head up display type technology projected on inside windows and/or a shade band of autonomous vehicle 110. Such “ghost” technology may be a projection onto any window or interior surface that is readable from outside the vehicle. In some embodiments, body panels and/or door handles that project messages through to a surface of the body panels or door handles may be utilized to project the visible image.

Item storage feature 132 may be any storage solution (e.g., bins, shelves, etc.) that are suitable for holding passenger items during an autonomous ride reservation. For example, item storage feature 132 may be a shelf/container that holds items (bags, computer case, etc.) brought to the vehicle by the customer. In some embodiments, item storage feature 132 is a transparent material for easy identification of items left behind by passengers. In some embodiments, item storage feature 132 includes a retrieval and secure storage solution. For example, item storage feature 132 may be a bin that tilts to allow the passenger's personal item to slide into a secure storage compartment when controller 120 determines that the passenger has departed without the personal item.

In the embodiment provided, item storage feature 132 is in communication with sensors 122 to detect the presence of items placed there. Sensors 122 are capable of determining basic characteristics of items placed in storage feature 132, such as general size, weight, material, number of items, etc. In some embodiments, there are multiple item storage features 132 in autonomous vehicle 110. Based on the profile of the customer/reservation-maker, controller 120 knows to remind or alert the customer about the items they've placed in the storage area as the journey draws to a close. Accordingly, controller 120 reduces the chances of the customer will mistakenly leave items behind after exiting the vehicle.

Personal device 112 may be any suitable device, such as a mobile telephone, conventional personal laptop or tablet computer, etc. Network 114 may include any number of public or private data connections, links or network connections supporting any number of communications protocols. The communication network may include the Internet, for example, or any other network based upon TCP/IP or other conventional protocols. In various embodiments, the communication network could also incorporate a wireless and/or wired telephone network, such as a cellular communications network for communicating with mobile phones, personal digital assistants, and/or the like. Server 115 is a computer device or collection of computer devices tasked with supporting and/or instructing autonomous vehicle 110 to perform operations associated with the methods described below. For example, server 115 may be a “back office” where autonomous vehicle passenger service reservations are stored and processed.

Referring now to FIG. 1B, a method 160 for operating an autonomous vehicle passenger service is illustrated. The various tasks performed in connection with method 160 may be performed by software, hardware, firmware, or any combination thereof. For illustrative purposes, the following description of method 160 may refer to elements mentioned above in connection with FIG. 1A. For example, various tasks of method 160 may be performed by autonomous vehicle 110, by personal device 112, or by server 115. In some embodiments, tasks of method 160 may be performed by alternative or additional devices. It should be appreciated that method 160 may include any number of additional or alternative tasks, that the tasks shown in FIG. 1B need not be performed in the illustrated order, and that method 160 may be incorporated into a more comprehensive procedure or process having additional functionality not described in detail herein. Moreover, one or more of the tasks shown in FIG. 1B may be omitted from an embodiment of method 160 as long as the intended overall functionality remains intact.

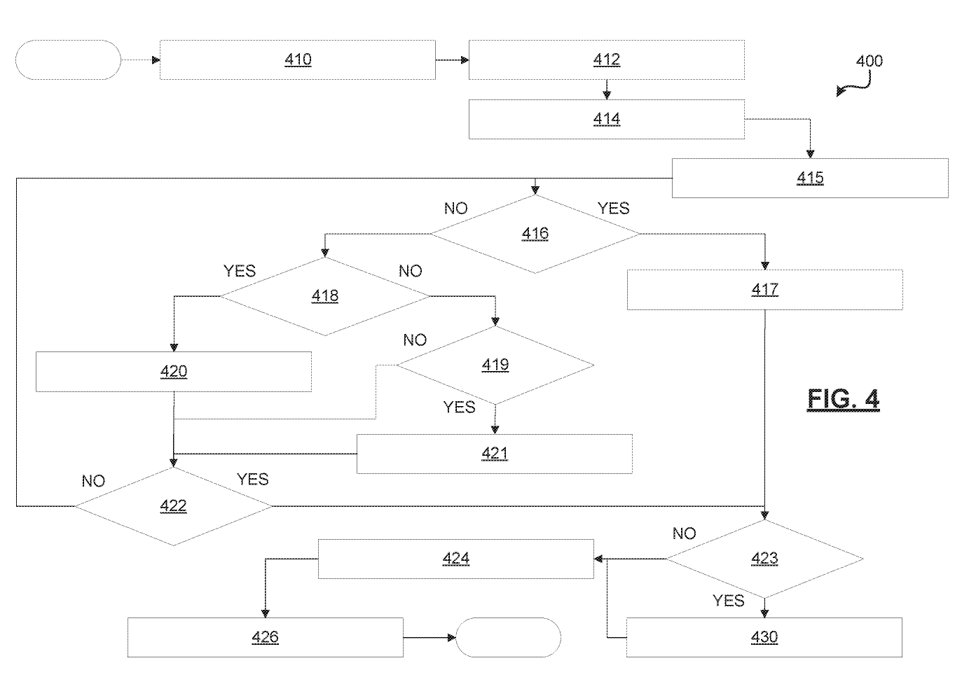

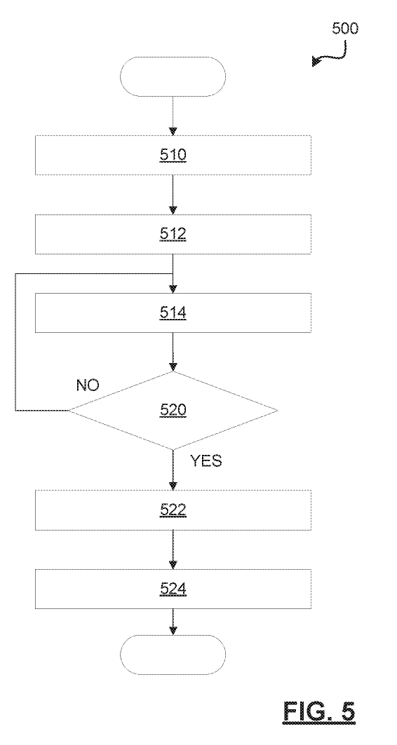

A controller instructs an autonomous vehicle to pick up a passenger in task 165. For example, server 115, personal device 112, or controller 120 may instruct autonomous vehicle 110 to pick up a passenger in by identifying the vehicle for the passenger in accordance with FIG. 4 and/or FIG. 5. In some embodiments, passenger pick up includes assigning a vehicle according to security/safety settings, vehicle dynamics, and co-occupant assignments. In some embodiments, the controller monitors internal and external risk factors during the journey and identifies unplanned events. In response to the unplanned events, the controller may initiate evasive action, remediation, or offer choices to the passenger.

The controller initiates ride share operations in task 170. For example, server 115, personal device 112, or controller 120 may perform various tasks of FIG. 3 and/or FIG. 4.

The controller monitors the passenger exiting the vehicle in task 175. For example, server 115, personal device 112, or controller 120 may perform various tasks of FIG. 2 and/or FIG. 4. For example, the controller may scan exit point for hazards or threats. When a hazard or thread is detected, the controller may find a safer place for the passenger to exit based on the passenger profile, passenger choices, and based on context and situations.

The controller concludes the passenger service in task 180. For example, server 115, personal device 112, or controller 120 may perform various tasks of FIG. 2 and/or FIG. 4. In some embodiments, the controller secures items left behind by the passenger.

FIG. 2 is a flow chart illustrating an exemplary embodiment of a method 200 for monitoring personal property of a passenger in an autonomous vehicle ride service. The various tasks performed in connection with method 200 may be performed by software, hardware, firmware, or any combination thereof. For illustrative purposes, the following description of method 200 may refer to elements mentioned above in connection with FIG. 1A. In some embodiments, tasks of method 200 may be performed by alternative or additional devices. It should be appreciated that method 200 may include any number of additional or alternative tasks, that the tasks shown in FIG. 2 need not be performed in the illustrated order, and that method 200 may be incorporated into a more comprehensive procedure or process having additional functionality not described in detail herein. Moreover, one or more of the tasks shown in FIG. 2 may be omitted from an embodiment of method 200 as long as the intended overall functionality remains intact.

A controller of a vehicle receives signal inputs from at least one of a sensor and a personal device in task 210. For example, controller 120 may receive sensor inputs from sensors 122 or signals from personal device 112 in task 210. The controller processes the signal inputs to determine whether passenger personal property is stowed in the vehicle in task 212. For example, controller 120 may process sensor signals from weight sensor 152 to determine that personal property is located in item storage feature 132. In some embodiments, controller 120 infers that there may be items stowed based on the number and location of panel openings and closings. For example, if the trunk was opened at the start of a reservation, then controller 120 may infer that an item was left behind in the trunk if the trunk was not opened again when the passenger departed the vehicle.

When no personal property is stowed in task 214, then method 200 may end or continuously repeat itself. When personal property is stowed in task 214, the controller determines the locations, dimensions, and weight of the personal property in tasks 216, 218, and 220. For example, controller 120 may determine the weight, locations, and dimensions of personal property stowed in item storage feature 132 based on the sensor signals received from sensors 122.

The controller compares the current vehicle position with a final destination position in task 222. When the vehicle is not near the final destination as determined by the controller in task 224, method 200 returns to task 222. When the vehicle is near the final destination, the controller displays representation of the stowed property as a reminder to the passenger in task 226. For example, controller 120 may display a schematic of autonomous vehicle 110 on display 128 with a visual representation of the stowed personal property located in item storage feature 132.

The controller processes the signal inputs to determine whether the passenger has exited the vehicle in task 228. For example, controller 120 may process inputs from door/deck lid/lift gate sensor 146 to determine if the passenger has exited autonomous vehicle 110. When the controller determines that the passenger has not exited the vehicle in task 230, method 200 returns to task 226. When the controller determines that the passenger has exited the vehicle in task 230, method 200 proceeds to task 232.

The controller processes the signal inputs to determine whether the personal property is still stowed in task 232. When the controller determines in task 234 that the personal property is not still stowed, method 200 ends. When the controller determines in task 234 that the personal property is still stowed in task 234, method 200 proceeds to task 236.

The controller alerts the passenger to the stowed personal property in task 236. For example, controller 120 may send an alert to personal device 112 or may use components of autonomous vehicle 110 to alert the passenger of the personal property that is still in the vehicle. In some embodiments, controller 120 sends a text or email retrievable on personal device 112 with a 360 picture of the interior of vehicle 110 attached to alert the passenger of personal items (e.g., sunglasses, hat, etc.) or trash left in vehicle 110. Components of autonomous vehicle 110 utilized for alerting may include interior speakers, interior lights, haptic devices, pop-up devices. In some embodiments, the vehicle chooses which alert methods and components to use based on personal preferences previously chosen by the passenger. In some embodiments, the vehicle may observe the passenger's behavior to determine what alerts should be employed to get the attention of the passenger without startling the passenger or being intrusive. In some embodiments, the alert methods based on the observed behavior is learned and stored for future use with the passenger. In some embodiments, the alert indicates the location of the item (e.g., console bin, trunk, seat, etc.).

The controller determines whether the personal property is still stowed in task 238. When the personal property is not still stowed in task 238, then method 200 ends. When the personal property is still stowed in task 238, then method 200 proceeds to task 240 to secure the personal property. For example, item storage feature 132 may tilt to allow the personal property to slide into a secure storage area for safe keeping in task 240. In some embodiments, autonomous vehicle 110 may be routed to a “lost and found” facility for a customer support representative to retrieve and store the personal property. In some embodiments, an intercept of the vehicle for retrieval is scheduled. In some embodiments, securing the personal property includes disallowing use to subsequent passengers of the storage space in which the personal property is secured. In some embodiments, the controller allocates charges to the passenger for continuing use of the storage space.

Referring now to FIG. 3, a method 300 for matching ride sharing passenger in an autonomous vehicle ride service is illustrated in accordance with the teachings of the present disclosure. The various tasks performed in connection with method 300 may be performed by software, hardware, firmware, or any combination thereof. For illustrative purposes, the following description of method 300 may refer to elements mentioned above in connection with FIG. 1A. In some embodiments, tasks of method 300 may be performed by alternative or additional devices. It should be appreciated that method 300 may include any number of additional or alternative tasks, that the tasks shown in FIG. 3 need not be performed in the illustrated order, and that method 300 may be incorporated into a more comprehensive procedure or process having additional functionality not described in detail herein. Moreover, one or more of the tasks shown in FIG. 3 may be omitted from an embodiment of method 300 as long as the intended overall functionality remains intact.

A controller receives first passenger data and preferences for a first passenger of an autonomous vehicle in task 310. For example, a server on network 114 or controller 120 may receive the data and preferences from a software application present on personal device 112. The first passenger may be a future passenger yet to be picked up or may be a current passenger already on route to a destination in autonomous vehicle 110. The controller receives second passenger data and preferences for a potential second passenger for a rides share of the autonomous vehicle in task 312. For example, the server or controller 120 may receive the data and preferences from a software application present on a personal device of the second potential passenger.

The controller compares the first passenger data and preferences to the second passenger data and preferences in task 314. The controller determines whether the first passenger and the second potential passenger are compatible in task 316. For example, the server or controller 120 may compare the interests, personal preferences, hobbies, activities, disallowed qualities between potential co-rider profiles and preferences, and other data to determine whether the first passenger and the second potential passenger are compatible in task 314 and 316. When the passengers are not compatible, method 300 proceeds to task 318 to deny the ride share. For example, the server or controller 120 may assign a different autonomous vehicle to pick up potential second potential passenger based on the determination of incompatibility. In some embodiments, such as a passenger service hailing scenario, the controller may not have information regarding the second passenger. In such scenarios, the controller may base the comparison on information that is identifiable by the vehicle or may omit task 314. For example, sensors 122 may determine that the second passenger is a male. The controller may then base the comparison on preferences of the first passenger (e.g., prefers not to ride share with males) or perceived mismatches based on aggregated user preferences.

When the passengers are compatible in task 316, the controller determines whether the first passenger has denied the second potential passenger in task 320. For example, the first passenger may have previously denied the second potential passenger based on a previous encounter. In some embodiments, controller 120 or the server presents information regarding the second potential passenger to the first passenger to permit the first passenger to accept or deny the ride share request. For example, the vehicle may present the information on display 128 for the user to accept or deny using user input device 126 when the second potential passenger is hailing the vehicle for a ride share without prior reservations, or when the second passenger is requesting a pickup from a remote location. In some embodiments, the controller may present information about whether the second passenger is traveling with pets.

In some embodiments, the vehicle may be selectively configured to partition or sub-divide the passenger cabin in response to passenger privacy preferences, incompatibilities between passengers, or inputs from any of the passengers when there is sufficient time to partition the cabin. In some embodiments, the controller requests permission from at least one of the passengers to command partitioning of the cabin or other interior space. In some embodiments, vehicle 110 includes a partition that may be manually deployed by the first passenger or the second passenger.

When the first passenger has denied the second potential passenger in task 320, method 300 proceeds to task 318 to deny the ride share request. When the first passenger has not denied the second potential passenger in task 320, method 300 proceeds to task 322 to initiate the ride share with the first passenger and the second potential passenger in autonomous vehicle 110.

Referring now to FIG. 4, a method 400 for promoting passenger safety and security in an autonomous vehicle ride service is illustrated in accordance with the teachings of the present disclosure. The various tasks performed in connection with method 400 may be performed by software, hardware, firmware, or any combination thereof. For illustrative purposes, the following description of method 400 may refer to elements mentioned above in connection with FIG. 1A. In some embodiments, tasks of method 400 may be performed by alternative or additional devices. It should be appreciated that method 400 may include any number of additional or alternative tasks, that the tasks shown in FIG. 4 need not be performed in the illustrated order, and that method 400 may be incorporated into a more comprehensive procedure or process having additional functionality not described in detail herein. Moreover, one or more of the tasks shown in FIG. 4 may be omitted from an embodiment of method 400 as long as the intended overall functionality remains intact.

In some examples, method 400 promotes positive identification of a reserved vehicle through individualized signaling. For example, method 400 may utilize augmented reality, intercept guidance, synchronization of visual/haptic elements with a personal device, or a personally programmed external display (identifier, icon, color, rhythmic lights, whole/part vehicle programmable display LEDs).

A controller initiates an autonomous passenger service pick up in task 410. For example, controller 120 may initiate pick up procedures for passenger 30 by traveling to a parking or stopping space near passenger 30. The controller projects a likeness or other personal identification on an exterior portion of the vehicle in task 412. For example, controller 120 may cause projector 130 to project a likeness of passenger 30 on a window or window shade of autonomous vehicle 110 as the vehicle approaches passenger 30. Accordingly, passenger 30 will be alerted that autonomous vehicle 110 is the vehicle assigned the passenger service reservation. In some embodiments, controller 120 may project a pass phrase or other information that is known by passenger 30 but does not personally identify passenger 30 to other pedestrians.

The controller alerts the passenger to the approaching vehicle in task 414. For example, controller 120 may send an alert through network 114 to cause a software application on personal device 112 to vibrate based on the distance between autonomous vehicle 110 and personal device 112. Similarly, controller 120 may synchronize the vibrations (haptic alert) with lights or other alerts projected from autonomous vehicle 110. The controller initiates the ride in task 415. For example, controller 120 may instruct autonomous vehicle 110 to begin driving when passenger 30 is secure in autonomous vehicle 110.

The controller determines whether a ride termination request has been received in task 416. For example, passenger 30 may command or request a ride termination using a gesture (e.g., specific hand/head/foot/body movements), user input device 126, a spoken phrase, or personal device 112. When a ride termination request has been received, method 400 proceeds to task 417. The controller instructs the autonomous vehicle to drop off the passenger at a nearby location in task 417. For example, controller 120 may disregard the current destination to drop off passenger 30 at the nearby location. In some embodiments, the controller covertly selects the new destination and pulls over to let the passenger out as if the nearby destination was the original destination. Such a covert destination change may be desirable when, for example, the passenger wishes to terminate a ride share with a non-familiar co-passenger without alerting the co-passenger to the passenger's desire to terminate the ride share. In some embodiments, the controller schedules a follow up between the passenger and customer service personnel to determine whether authorities should be notified and/or to assist the passenger with obtaining an expedited reservation for a new vehicle.

When a ride termination request has not been received, method 400 proceeds to tasks 418 and 420. The controller determines whether to enter a panic or emergency mode in task 418. For example, controller 120 may receive a panic or emergency command from user input device 126 or personal device 112 to indicate the panic or emergency mode. When the passenger has not commanded the emergency or panic mode in task 418, method 400 proceeds to task 419.

The controller determines whether a threat exists at the current destination in task 419. For example, controller 120 may determine that mobility hazards such as ice are present at the current destination. In some embodiments, controller 120 may determine that a threat exists when large groups of unruly persons are present at the current destination. In some embodiments, controller 120 determines a threat exists based on passenger verbal instructions or a user interface input by the passenger. When no threat exists, method 400 proceeds to task 422.

When a threat exists, method 400 proceeds to task 421. The controller selects a new destination at task 421. For example, controller 120 may select a new destination that does not have a threat as the new destination.

When the passenger has commanded the panic or emergency mode in task 418, method 400 proceeds to task 430 to perform safety procedures. For example, autonomous vehicle may engage a safeguard mode as described above, may initiate human communication using wireless communications device 124, or may instruct autonomous vehicle 110 to drive to the nearest police station or medical facility. In some embodiments, a potential passenger may initiate an emergency request of an autonomous vehicle by some established convention. For example, a potential passenger may dial 911 with an extension (e.g., 911-8 or similar) to dispatch an autonomous vehicle to the GPS location of the emergency request as a type of “escape pod” in addition to connection with a 911 operator.

The controller determines whether the ride is complete in task 422. For example, controller 120 may compare a current Global Navigation Satellite System (GNSS) position to a GNSS position of the requested final destination in task 422. When the ride is not complete, method 400 returns to task 416 to continuously monitor for the termination and panic mode requests.

When the ride is complete, method 400 proceeds to task 423 to determine whether there is an emergency situation. For example, autonomous vehicle 110 may wait a specified amount of time after passenger departure and analyze sensor and mobile device signals to detect abrupt or aggressive movements, loud noises or voices, distress words, or other conditions indicating an emergency situation. In some embodiments, controller 120 or server 115 performs security procedures after the departure based on user preferences. For example, autonomous vehicle 110 may record a video of the passenger until the passenger is no longer visible. Controller 120 or server 115 may then send the video or other indicator to a contact person associated with the passenger. For example, controller 120 or server 115 may send a video of a passenger exiting the vehicle and entering a house to a concerned party associated with the passenger (e.g., parent, spouse, etc.).

When there is an emergency situation, method 400 proceeds to task 425 to perform safety procedures. The safety procedures of task 425 may be similar to the safety procedures of task 420. In some embodiments, controller 120 may take emergency response action in response to a quick passenger return to autonomous vehicle 110 combined with a detected emergency situation. For example, the controller may lock the doors of the autonomous vehicle once the passenger has entered the autonomous vehicle, may initiate quick departure without user prompt or instructions once passenger has entered the autonomous vehicle, may contact a call center to engage customer care, or may take other suitable emergency response actions.

The controller determines whether maintenance on the vehicle is required in task 424. For example, controller 120 may monitor the number of miles since the last oil change, the tire pressure levels, the gas tank fill level, or other portions of autonomous vehicle 110 that may require attention before beginning the next reservation. The controller sends the vehicle to the next destination based on the maintenance determination in task 426. For example, when maintenance is required, controller 120 may instruct autonomous vehicle 110 to travel to a maintenance or other service location to be serviced. When maintenance is not required, controller 120 may instruct autonomous vehicle 110 to pick up the next passenger, to travel to a staging lot or location in anticipation of the next passenger. In some embodiments, the staging lot or location is based on where likely next passenger will summon from with location data from all fleet vehicles and traffic patterns/time of day/events going on/ weather influences/public transportation issues or operation data.

Referring now to FIG. 5, a method 500 for assisting with passenger identification of a reserved vehicle is illustrated in accordance with the teachings of the present disclosure. The various tasks performed in connection with method 500 may be performed by software, hardware, firmware, or any combination thereof. For illustrative purposes, the following description of method 500 may refer to elements mentioned above in connection with FIG. 1A. In some embodiments, tasks of method 500 may be performed by alternative or additional devices. It should be appreciated that method 500 may include any number of additional or alternative tasks, that the tasks shown in FIG. 5 need not be performed in the illustrated order, and that method 500 may be incorporated into a more comprehensive procedure or process having additional functionality not described in detail herein. Moreover, one or more of the tasks shown in FIG. 5 may be omitted from an embodiment of method 500 as long as the intended overall functionality remains intact.

In general, once a shared vehicle reservation is confirmed, a system or server sends a unique animated graphic to the confirmed rider and to the vehicle being reserved. When the vehicle arrives at its rendezvous point, the vehicle projects the image onto the whole or a part of the exterior of the vehicle so that the confirmed rider can easily identify their ride. In some embodiments, the graphic is visible on integrated display monitors on all four sides of the vehicle. In some embodiments, the vehicle does not project the image, but personal device 112 includes an augmented vision display that accentuates autonomous vehicle 110 approaching the passenger.

More specifically, a controller confirms a reservation of an autonomous vehicle for a passenger in task 510. For example, a server on network 114 or controller 120 may confirm a ride reservation in autonomous vehicle 110 for passenger 30. The controller identifies a type of mobile device used by the passenger is task 512. For example, the server or controller 120 may determine whether personal device 112 is a smartphone or a folding flip type mobile phone in task 512.

The controller selects a graphic based on the personal device type in task 514. For example, the server or controller 120 may select an animated graphic for a smartphone and a bright still image for the folding flip type mobile phone. In some embodiments, the graphic is randomly generated and is changed for each reservation to protect passenger identify. In some embodiments, the graphic changes and synchronizes with personal device 112 in a specified pattern or in layered patterns. In some embodiments, the graphic or rhythm is preset by the passenger in profile preferences of the passenger.

The controller determines whether the graphic is unique within a predetermined area of a pickup location in task 520. For example, the server or controller 120 may compare the graphic with other graphics selected for different passengers having different reservations with pickup locations that are within 400 yards of the pickup location for passenger 30. When the graphic is not unique, method 500 returns to task 514 to select a different graphic. Accordingly, the system does not use the same graphic in the same area to reduce potential confusion about who has reserved which vehicle. When the graphic is unique, method 500 proceeds to task 522.

The controller sends the graphic to the passenger personal device in task 522. For example, the server or controller 120 may send the graphic to personal device 112 for display on personal device 112. The controller causes the autonomous vehicle to project the graphic in task 524. For example, the server or controller 120 may cause projector 130 to project a likeness of passenger 30 on a window or window shade of autonomous vehicle 110 as the vehicle approaches passenger 30. In the example provided, the window shade is a shade band with a portion of the windshield having a shading dot matrix ink or a smart glass type of band that can be varied in opaqueness. Projecting the image onto the window shade may be by a projector projecting onto the glass or by controlling the window band to display the graphic. In some embodiments, body panels of autonomous vehicle 110 are coated or embedded with display materials to project the image (e.g., organic light emitting diodes (OLEDs), light panels, etc.). By sending the graphic to the passenger and projecting the graphic at the autonomous vehicle, method 500 promotes accurate vehicle identification by the passenger at the pickup location. Accordingly, method 500 assists users of shared vehicles with identification of their reserved vehicle when there are other shared vehicles present.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a vehicle, the method comprising:
selecting an identifier that is associated with a vehicle reservation for passenger service in the vehicle;
initiating a pick-up portion of the vehicle reservation for making the vehicle available to a passenger; and
displaying the identifier at the vehicle during the pick-up portion of the passenger service.

2. The method of claim 1, wherein displaying the identifier includes displaying the identifier on a shade band of the vehicle.

3. The method of claim 1, further comprising ceasing the displaying in response to a pick-up of the passenger, and wherein the vehicle is an autonomous vehicle.

4. The method of claim 1, wherein selecting the identifier includes selecting a graphic that is unique to the vehicle reservation within a predetermined distance from a pick-up location.

5. The method of claim 4, wherein selecting the identifier further includes randomly generating the graphic.

6. The method of claim 4, further comprising sending the identifier to a personal device of the passenger to assist with passenger identification of the vehicle.

7. The method of claim 1, wherein displaying the identifier includes displaying a likeness of the passenger.

8. The method of claim 1, further comprising:
determining whether a first passenger and a second passenger are compatible;
initiating a ride share of the vehicle with the first passenger and the second passenger based at least in part on whether the first passenger and the second passenger are compatible.

9. The method of claim 8, further comprising denying the ride share in response to receiving a denial request from the first passenger.

10. The method of claim 8, further comprising covertly altering a destination of the first passenger to a nearby location in response to a termination request by the first passenger during the ride share.

11. The method of claim 1, further comprising performing safety procedures in response to receiving a panic mode indication.

12. The method of claim 1, further comprising
monitoring the passenger following departure of the passenger;
notifying a contact person in response to a safe arrival of the passenger at a destination;
detecting an emergency situation following departure of the passenger; and
initiating an emergency response action in response to detection of the emergency situation and a return of the passenger to the vehicle.

13. The method of claim 1, further comprising:
determining whether a threat exists at a current destination; and
selecting a new destination in response to determining that the threat exists at the current destination.

14. A method, comprising:
operating an autonomous vehicle for a passenger;
sensing whether an item of personal property is disposed in the autonomous vehicle;
detecting whether the passenger has left the autonomous vehicle; and
alerting the passenger to the presence of the item of personal property in the autonomous vehicle in response to determining that the passenger has left the autonomous vehicle.

15. The method of claim 14, further comprising securing the item of personal property in a storage space in response to detecting that the passenger has not retrieved the item of personal property, wherein securing the item of personal property includes disallowing use of the storage space by a subsequent passenger.

16. The method of claim 15, further comprising allocating charges to the passenger for continued use of the storage space.

17. The method of claim 14, further comprising alerting the passenger to the presence of the item of personal property in response to the autonomous vehicle nearing a destination of the vehicle reservation.

18. The method of claim 17, wherein alerting the passenger includes displaying a representation of the item of personal property.

19. The method of claim 18, further comprising determining a dimension and a location of the item of personal property, and wherein displaying the representation is based on the dimension and the location.

20. A server comprising:
a processor; and
a non-transitory computer readable medium storing instructions that configure the server for:
selecting an identifier that is associated with a vehicle reservation for passenger service in an autonomous vehicle;
initiating a pick-up portion of the vehicle reservation for making the autonomous vehicle available to a passenger; and
displaying the identifier at the autonomous vehicle during the pick-up portion of the passenger service.
